(19) United States
(12) Patent Application Publication
(10) Pub. No.: US 2006/0213598 A1
(43) Pub. Date: Sep. 28, 2006

(54) Method for forming a micro-reflecting film

(75) Inventors: Chien-Chiu Peng, Ping Chen (TW); Hsin-Hsing Li, Ping Chen (TW); Chang-Yi Chen, Ping Chen (TW)

Correspondence Address: NIKOLAI & MERSEREAU, P.A., 900 SECOND AVENUE SOUTH, SUITE 820, MINNEAPOLIS, MN, 55402, US

(73) Assignee: OPTIMAX TECHNOLOGY CORPORATION, Ping Chen (TW)

(21) Appl. No.: 11/288,001

(22) Filed: Nov. 28, 2005

(30) Foreign Application Priority Data
Mar. 25, 2005 (TW) 094109438

(51) Int. Cl. B32B 38/00; B32B 37/00

(52) U.S. Cl. 156/60

(57) ABSTRACT

A method for forming a micro-reflecting film, which is applied to a polarized plate and a display device, for efficiently reflecting light from external source to increase a refractive index, comprises: mixing a transparent resin and a solution having a plurality of micro-reflecting particles to form a micro-reflecting solution; coating the micro-reflecting solution on a protecting film to form a micro-reflecting film with a free surface opposite the protecting film; drying the micro-reflecting layer with the protecting film; and attaching the free surface of the micro-reflecting layer on one surface of a transparent substrate to form a micro-reflecting film with the protecting film.

### BACKGROUND OF THE INVENTION

1. Field of the Invention

The present invention relates to a method for forming an optical film, and particularly to a method for forming a micro-reflecting film; the micro-reflecting film is applied to polarized plates and a display device so as to efficiently reflect light from an external source and result in an increase of a reflective index.

2. Description of the Prior Art

A display device is an important tool in modern society. Instant display and especially portable communication devices have become even more ubiquitous than wristwatches. The electronic devices, such as cell phones, digital cameras functioning simultaneously as personal digital assistants, and guidance systems using global satellites, arrived with the advanced technology, and functions of those devices are continuously being expanded.

The attached functions of traditional compact display devices are continuously expanded to satisfy the needs of consumers, such as applying cell phones combined with digital cameras and multimedia; therefore, the method of reducing electricity consumption is the key focus of technological improvement.

Traditional low-level half reflecting and half passing devices, and cell phones of STN-type display modes are approximately classified into an operating mode and a waiting mode. In the operating mode, light from backlight elements is provided to a display by using an internal battery; in the waiting mode, some simple information, such as time display is shown on display plate while the backlight elements are closed; however, such simple function of the display plate is not enough for a color display.

Another full color TFT cell phone includes another waiting mode; if not operated for a long time, the system enters a waiting state; although light from backlight elements is not provided, simple signals are shown on the display plate or a color display plate by using external source via a reflecting principle. Efficiently passing light from backlight elements in the operating mode, and efficiently reflecting light from an external source in the waiting mode have become important subjects so as to achieve the purpose of reducing consumption of electricity.

According to the present invention, a structure of a micro-reflecting layer is provided for efficiently raising the effect of reflecting light from an external source to solve the foregoing problems.

### SUMMARY OF THE INVENTION

Accordingly, the main object of the present invention, a method of forming a micro-reflecting film is provided. Light from a backlight source passes through the micro-reflecting film, and a reflective index of light from external source is efficiently increased without using the backlight source; thus, the purpose of reducing consumption of electricity is achieved.

According to the foregoing objects, the present invention provides a method of forming micro-reflecting films, which is used for polarized plates and display device of small physical size, such as cell phones, digital cameras, personal digital assistants and satellite-based global positioning systems (GPS). The method for forming the micro-reflecting film includes: providing a transparent resin and a solution having a plurality of micro-reflecting particles; mixing the transparent resin and the solution having the plurality of micro-reflecting particles to form the micro-reflecting solution; coating the micro-reflecting solution on one surface of a protecting film for forming a micro-reflecting layer with a free surface opposite the protecting film; drying the micro-reflecting layer coated on the protecting film; and attaching the free surface of the micro-reflecting layer on one surface of a transparent substrate for forming a micro-reflecting film with the protecting film.

According to the method of forming the micro-reflecting film above-mentioned, the micro-reflecting film includes a micro-reflecting layer and a transparent substrate. The micro-reflecting layer includes: a transparent resin layer, and a plurality of micro-reflecting particles. By uniformly mixing the plurality of micro-reflecting particles and the transparent resin layer, light from an external source partially passes through the micro-reflecting particles and the transparent resin layer, and is also partially reflected by the micro-reflecting particles.

Furthermore, a plurality of optical diffusing particles is added into the solution having micro-reflecting particles for uniformly light diffusing. With the half-transparent and half-reflecting properties, a display effect is achieved by reflecting light from an external source while the source of the backlight is closed. Thus, the purpose of reducing consumption of electricity is achieved.

The objects, features, and effects of the present invention will be more readily understood by those who skilled in the arts with providing detailed description of the preferred embodiment with the appended drawings.

### BRIEF DESCRIPTION OF THE DRAWINGS

FIG. 1 is flow chart of forming the micro-reflecting film of the present invention;

FIG. 2 is schematic view of forming the micro-reflecting film in accordance with FIG. 1;

FIG. 3 is another preferred embodiment of forming the micro-reflecting film according to the present invention; and

FIG. 4 is schematic view of forming the micro-reflecting film in accordance with FIG. 3.

### DETAILD DESCRIPTION OF THE PREFERRED EMBODIMENT

The present invention will be explained below in conjunction with embodiments.

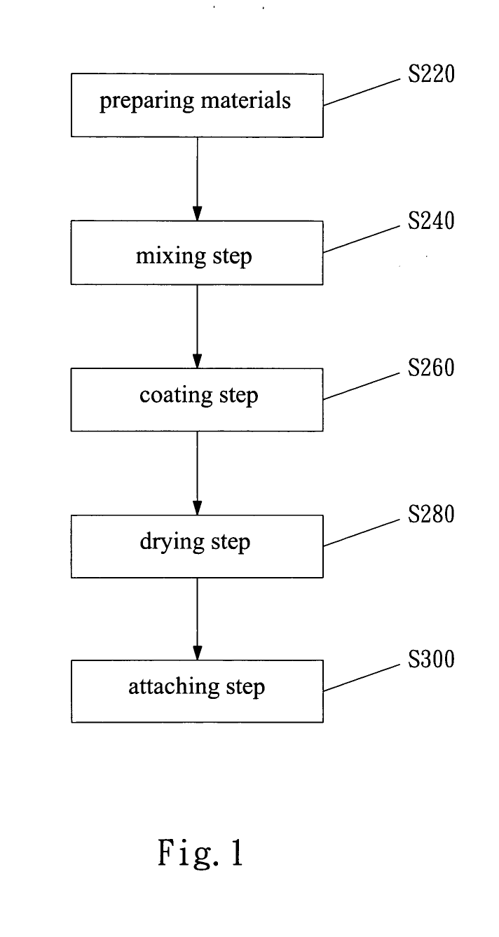

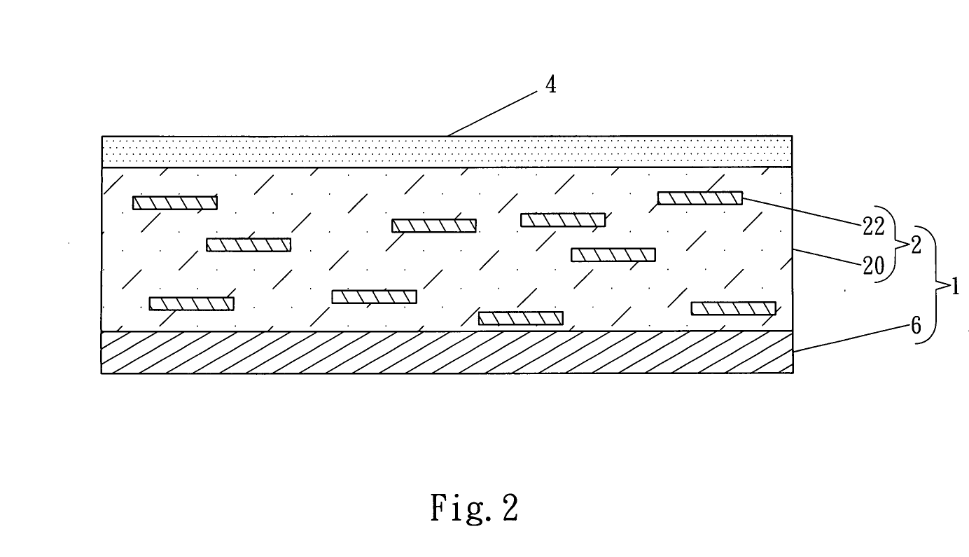

Referring to FIG. 1 and FIG. 2, FIG. 1 is flow chart of forming micro-reflecting film of the present invention; FIG. 2 is schematic view of forming the micro-reflecting film in accordance with FIG. 1. Referring to FIG. 1, the forming method includes following steps: preparing materials S220, providing a transparent resin 20 and a solution having a plurality of micro-reflecting particles 22; mixing S240, uniformly mixing transparent resin 20 and a solution having a plurality of micro-reflecting particles 22; coating S260, coating the micro-reflecting solution on a protecting film 4 to form a micro-reflecting layer 2 with a free surface opposite the protecting film 4; drying S280, drying the micro-reflecting layer 2 coated on the protecting film 4; and attaching S300, attaching the free surface of the micro-reflecting layer 2 on one surface of a transparent substrate 6 for forming a micro-reflecting film 1 with the protecting film 4.

In step S220, the transparent resin 20, the refractive index of which ranges between 1.3 and 1.6, has good light transparency; the transparent resin 20 is Acrylic resin in accordance with the preferred embodiment of the present invention. The solution having a plurality of micro-reflecting particles includes: a plurality of micro-reflecting particles 22 and a solvent; the micro-reflecting particles 22,the refractive index of which ranges between 1.3 and 1.6 and radius of particle size ranges between 1 and 50 μm, have half passing and half reflecting properties; according to the present invention, the micro-reflecting particles 22, are selected from Aluminum oxide(Al2O3) Titanium dioxide(TiO2) or Silicon dioxide(SiO2). The solvent is in the form of an organic solvent or a mixture of several solvents; the solvent is formed by mixing Toluene, Acetone, and Ethyl acetate in accordance with the preferred embodiment.

In step 240, transparent resin 20 and the plurality of micro-reflecting particles 22 are uniformly mixed so as to form micro-reflecting particles without specific form or method. According to the preferred embodiment, the mixing procedure is performed as a batch stirring way. After mixing step S240, a defoaming step is carried out for removing foam from the solution. The defoaming step is without specific form or method; in terms of the preferred embodiment, a pressure difference is used for forcing the foam out and then the foam is removed.

In step S260, the micro-reflecting solution is contained in a coating device; with the coating head of the coating device, the micro-reflecting solution is coated on the protecting film 4, which is preferred to be an releasing film; therefore, a micro-reflecting layer 2 with the protecting films is formed.

In step S280, a micro-reflecting layer 2 with the protecting film 4 is delivered to a dryer device for drying; in the preferred embodiment of the present invention, an oven is used with a temperature ranging between 50˜150° C. the drying time ranging between 1˜5 min., and the thickness of the film ranging between 15˜50 μm.

In step S300, attaching the free surface of the micro-reflecting layer 2 on one surface of a transparent substrate 6 for forming a micro-reflecting film 1 with the protecting film 4(referring to FIG. 2). According to the present invention, the transparent substrate 6 is selected from Polyethylene terephthalate (PET) Triacetyl cellulose(TAC) Polycarbonate(PC) or other transparent materials.

Referring to FIG. 2, the micro-reflecting film 1 of the present invention is applied to polarized plates and a display device, especially a display device such as a cell phone, a combined camera and personal digital assistant, and a guiding system using global satellites. The micro-reflecting film 1 includes a micro-reflecting layer 2 and a transparent material 6. The micro-reflecting layer 2 is formed of a transparent resin 20 and a plurality of micro-reflecting particles 22. The transparent resin 20, the refractive index of which ranges between 1.3 and 1.6, has the property of light passing through it. The transparent resin of the present invention is Acrylic resin. A plurality of micro-reflecting particles 22 with the property of light half passing through it and light half reflecting therefrom, the refractive index of which ranges between 1.3 and 1.6 and radius of particle size ranges between 1 and 50 μm, is uniformly inserted into the transparent resin 20. The plurality of micro-reflecting particles 22 is selected from Aluminum oxide(Al2O3) Titanium dioxide(TiO2) or Silicon dioxide(SiO2), and the percentage of weight in the transparent resin 20 ranges between 1 and 20. The transparent substrate (6) is selected from Polyethylene terephthalate (PET), Triacetyl cellulose (TAC), Polycarbonate (PC) or other transparent materials.

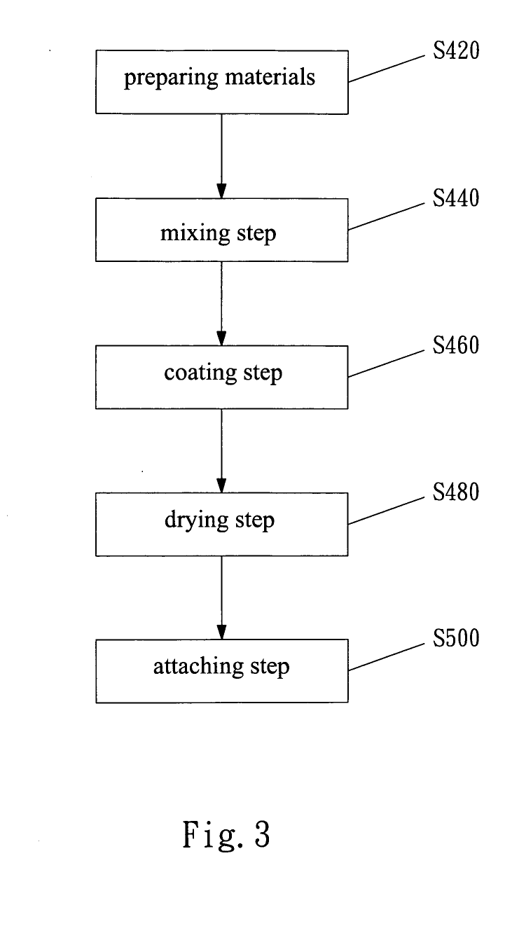

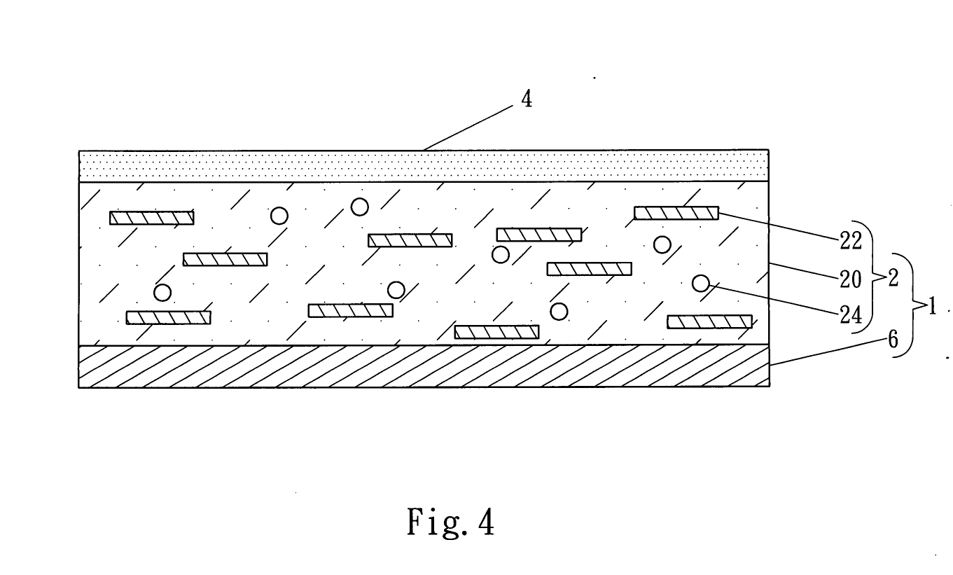

FIG. 3 is another preferred embodiment of forming the micro-reflecting film according to the present invention; and FIG. 4 is schematic view of forming the micro-reflecting film in accordance with FIG. 3. The method of forming the micro-reflecting film comprises: preparing materials S420, providing a transparent resin 20 and a solution having a plurality of micro-reflecting particles 22 and a plurality of optical diffusing particles 24; mixing step S440, mixing the transparent resin 20, the plurality of micro-reflecting particles 22, and the plurality of optical diffusing particles 24 so as to form the micro-reflecting solution; coating step S460, coating the micro-reflecting solution on a protecting film 4 so as to form a micro-reflecting layer 2 with a free surface opposite the protecting film 4; drying step S480, drying the micro-reflecting layer 2 coated on the protecting film 4; and attaching step S500, attaching another surface of the micro-reflecting layer 2 on one surface of a transparent substrate 6, so as to form the micro-reflecting film with the protecting film 4.

In step S420, the transparent resin 20, the refractive index of which ranges between 1.3 and 1.6, has good light transparency; and the transparent resin is Acrylic resin in accordance with the preferred embodiment of the present invention. The solution for forming the micro-reflecting layer 2 includes: a plurality of micro-reflecting particles 22, a plurality of optical diffusing particles 24 and a solvent. The micro-reflecting particles 22 having light half passing through and light half reflecting therefrom, the refractive index of which ranges between 1.3 and 1.6 and the radius of particle size ranges between 1 and 50 μm, are selected from Aluminum oxide(Al₂O₃), Titanium dioxide(TiO₂), or Silicon dioxide(SiO₂) in accordance with the embodiment of the present invention. The optical diffusing particles 24 are used to diffuse incident light, the radius of particle size of which ranges between 1 ad 50 μm, are selected from Titanium dioxide (TiO₂), Silicon dioxide(SiO₂), and Silica. The solvent is in the form of an organic solvent or a mixture of several solvents; the solvent is formed by mixing Toluene, Acetone, and Ethyl acetate in accordance with the preferred embodiment.

In step S440, the transparent resin 20, the plurality of micro-reflecting particles 22 and the plurality optical diffusing particles 24 are mixed and used for forming the micro-reflecting solution. According to the present invention, the mixing step S440 is by the batch stirring method. After mixing step S440, a defoaming step is carried out for removing foam from the solution. The defoaming step is carried out without specific form or method, but according to the preferred embodiment, a pressure difference is used for forcing the foam out and then the foam is removed.

In step S460, the micro-reflecting solution is placed into a coating device; the micro-reflecting solution is coated on the transferred protecting film 4; the transferred protecting film 4 is superior releasing film; thus, a micro-reflecting layer 2 with the protecting film 4 is formed.

In step S480, the micro-reflecting layer 2 with the protecting film 4 is delivered to a drying device. An oven is used for the drying step in the preferred embodiment; the temperature ranges between 50 to 150° C.; and the drying time ranges between 1 to 5 minutes; after drying, the thickness of the micro-reflecting layer 2 ranges between 15 and 50 μm.

Referring to FIG. 4, in step S550, attaching the free surface of the micro-reflecting layer 2 on a transparent substrate 6. According to the embodiment, the transparent substrate 6 is selected from Polyethyleneterephthalate(PET) Triacetyl cellulose(TAC) Polycarbonate(PC) or other transparent materials.

Referring still to FIG. 4, the micro-reflecting film 1 is applied to a polarized plate and a display device, especially a display device of small physical size, such as a cell phone, a camera combined with a personal digital assistant and a guiding system using global satellites. The micro-reflecting film 1 includes a micro-reflecting layer 2 and transparent substrate 6. The micro-reflecting layer 2 is formed of a transparent resin 20, a plurality of micro-reflecting particles 22 and a plurality of optical diffusing particles 24. The transparent resin 20 having good transparent property, the refractive index of which ranges between 1.3 and 1.6, is selected from Acrylic resin. In the transparent resin 20, a plurality of micro-reflecting particles 22 and a plurality of optical diffusing particles 24 are uniformly mixed; therein, the micro-reflecting particles 22 having properties of light half passing through and light half reflecting from, the refractive index of which ranges between 1.3 and 1.6 and the radius of particle size ranges between 1 and 50 μm, is selected from Aluminum oxide(Al₂O₃) Titanium dioxide(TiO₂) or Silicon dioxide (SiO₂). The optical diffusing particles 24 uniformly diffuse incident light, the radius of size of which ranges between 1 and 50 μm, is selected from Titanium dioxide(TiO₂) Silicon dioxide(SiO₂) or Silica. The percentages of weight of the micro-reflecting particles 22 and the optical diffusing particles 24 range between 1˜20%. The transparent substrate 6 is selected from (Polyethylene terephthalate (PET) Triacetyl cellulose(TAC) Polycarbonate(PC) or other transparent materials. The thickness of the micro-reflecting film 1 which is formed of the micro-reflecting layer 2 and the transparent substrate 6, ranges between 50 and 100 μm. Therefore, according to the present invention, a method of forming a micro-reflecting film is provided; the micro-reflecting film is applied to polarized plates and display devices which having half transparent and half reflecting properties, high efficient of an external light source, and better brightness.

With the present invention described, it will be obvious that the same may be varied in many ways. Such variations are not to be regarded as a departure from the sprit and scope of the present invention, and all such modification would be obvious to one skilled in the art are intended to be included within the scope of the following claims.

What is claimed is:

1. A method of forming a micro-reflecting film, comprising:
preparing materials, providing a transparent resin and a solution having a plurality of micro-reflecting particles;
mixing step, mixing the transparent resin and the solution having a plurality of particles so as to form the micro-reflecting solution;
coating step, coating the micro-reflecting solution on a protecting film to form a micro-reflecting layer with a free surface opposite the protecting film;
drying step, drying the protecting film and the micro-reflecting layer; and
attaching step, attaching the free surface of the micro-reflecting layer on one surface of a transparent substrate to form a micro-reflecting film with the protecting film;
wherein the solution comprises a plurality of micro-reflecting particles and a solvent.

2. The method of forming a micro-reflecting film as recited in claim 1, wherein a defoaming step is proceeded after the mixing step and before the coating step.

3. The method for forming a micro-reflecting film as recited in claim 1, wherein the micro-reflecting layer is used to reflect an external light source; the micro-reflecting layer further comprises: the transparent resin, the reflective index of which ranges between 1.3 and 1.6, is used for light to pass through the micro-reflecting layer; and the plurality of micro-reflecting particles, which are uniformly distributed inside the transparent resin, the reflective index of which ranges between 1.3 and 1.6 and the radius of size ranges between 1 and 50 μm, are used to result in light from an external source partially passing through and partially being reflected from the micro-reflecting layer.

4. The method for forming a micro-reflecting film as recited in claim 1, wherein the transparent resin is Acrylic resin.

5. The method for forming a micro-reflecting film as recited in claim 1, wherein the micro-reflecting particles are selected from any one of Aluminum oxide, Titanium dioxide and Silicon dioxide.

6. The method for forming a micro-reflecting film as recited in claim 3, wherein the micro-reflecting particles are selected from any one of Aluminum oxide, Titanium dioxide and Silicon dioxide.

7. The method for forming a micro-reflecting film as recited in claim 1, wherein the transparent substrate is selected from any one of Polyethylene terephthalate, Triacetyl cellulose and Polycarbonate.

8. The method for forming a micro-reflecting film as recited in claim 1, wherein thickness of the micro-reflecting layer ranges between 50 and 100 μm.

9. The method of forming a micro-reflecting film as recited in claim 1, wherein the solvent is mixed with Toluene, Acetone, and Ethyl acetate.

10. A method of forming a micro-reflecting film, comprising:
providing a transparent resin, a plurality of micro-reflecting particles and a plurality of optical diffusing particles;
mixing the transparent resin, the plurality of micro-reflecting particles and the plurality of optical diffusing particles to form a micro-reflecting solution;
coating the micro-reflecting solution on a protecting film to form a micro-reflecting layer with a free surface opposite the protecting film;
drying the protecting film and the micro-reflecting layer; and attaching the free surface of the micro-reflecting layer on one surface of a transparent substrate to form a micro-reflecting film with the protecting film;
wherein the solution comprises a plurality of micro-reflecting particles and a solvent.

11. The method for forming a micro-reflecting film as recited in claim 10, wherein a defoaming step is proceeded before the coating step and after the mixing step to remove solution foam.

12. The method for forming a micro-reflecting film as recited in claim 10, wherein the micro-reflecting layer for reflecting light from an external source, comprises: the transparent resin, the refractive index of which ranges between 1.3 and 1.6, is used for light to pass through the micro-reflecting layer; and the plurality of micro-reflecting particles, the refractive index of which ranges between 1.3 and 1.6 and the radius of particle size ranges between 1 and 50 μm, are uniformly distributed inside the transparent resin and used to partially allow light from an external source to pass through and partially reflect light from the micro-reflecting layer;
the plurality of optical diffusing particles, the radius of particle size of which ranges between 1 and 50 μm, are uniformly distributed inside the transparent resin and used to uniformly diffuse light from an external source.

13. The method for forming a micro-reflecting film as recited in claim 10, wherein the transparent resin is Acrylic resin.

14. The method for forming a micro-reflecting film as recited in claim 10, wherein the micro-reflecting particles are selected from any one of Aluminum oxide, Titanium dioxide and Silicon dioxide.

15. The method for forming a micro-reflecting film as recited in claim 12, wherein the micro-reflecting particles are selected from any one of Aluminum oxide, Titanium dioxide and Silicon dioxide.

16. The method for forming a micro-reflecting film as recited in claim 10, wherein the plurality of optical diffusing particles are selected from any one of Titanium dioxide, Silicon dioxide and Silica.

17. The method for forming a micro-reflecting film as recited in claim 12, wherein the plurality of optical diffusing particles are selected from any one of Titanium dioxide, Silicon dioxide and Silica.

18. The method for forming a micro-reflecting film as recited in claim 10, wherein the transparent substrate is selected from any one of Polyethylene terephthalate, Triacetyl cellulose and Polycarbonate.

19. The method for forming a micro-reflecting film as recited in claim 10, wherein the thickness of the micro-reflecting film ranges between 50 and 100 μm.

20. The method of forming a micro-reflecting film as recited in claim 10, wherein the solvent is mixed with Toluene, Acetone, and Ethyl acetate.
